(19) United States
(12) Patent Application Publication
(10) Pub. No.: US 2026/0318033 A1
(43) Pub. Date: Oct. 15, 2026

(54) A MULTI-COUPLING DEVICE AND A WORKING VEHICLE

(71) Applicant: JOST UMEÅ AKTIEBOLAG, Umeå (SE)

(72) Inventors: Gustaf LAGUNOFF, Umeå (SE); Olof GIDLUND, Bonässund (SE); Tommy NILSSON, Umeå (SE)

(21) Appl. No.: 19/124,559

(22) PCT Filed: Oct. 27, 2023
(86) PCT No.: PCT/SE2023/051064

§ 371 Date: Apr. 25, 2025

(30) Foreign Application Priority Data
Oct. 28, 2022 (SE) 2251253-7

(51) Int. Cl. E02F 3/36

(52) U.S. Cl. CPC E02F 3/3654; E02F 3/3668

(57) ABSTRACT

The invention relates to a multi-coupling device (10) for connecting multiple hydraulic lines of a working vehicle (1) and a detachable equipment (100), the multi-coupling device (10) comprising: a first connection plate (20) configured to be fixedly attached to the working vehicle (1); and a second connection plate (40) configured to be moveably attached to the detachable equipment (100), wherein the first connection plate (20) and the second connection plate (40) comprise at least two corresponding female and male couplings and are configured to be connected, wherein the multi-coupling device (10) comprises a centrally arranged guiding pin (60) on the first or second connection plate (20, 40) and a corresponding centrally arranged guiding hole (62) in the first or second connection plate (20, 40) for receiving said guiding pin (60), and wherein the female couplings (50) have an inner conical section (54) for guiding the male couplings (30).

### TECHNICAL FIELD

The present invention relates a multi-coupling device for connecting multiple hydraulic lines of a working vehicle and a detachable equipment. The invention also relates to a working vehicle comprising such a multi-coupling device.

### BACKGROUND

Working vehicles or utility vehicles may be provided with various types of equipment, tools or implements in order to perform different work. Such an equipment may be a front loader provided with different tools, a snow blower or similar. The equipment is removably attached to the vehicle and there is typically a mechanical interface, such as a bearing box, for the mechanical connection. The equipment may comprise hydraulic parts and a hydraulic interface for connecting hydraulic lines on the vehicle with hydraulic lines on the equipment is therefore required. Some sort of hydraulic quick connect couplings are typically used. In some vehicles, quick connect couplings between the vehicle and the equipment are connected individually. In other vehicles, multi-couplings with multiple quick connect couplings are used in order to connect several hydraulic lines in a single manoeuvre. Depending on the equipment, different number of hydraulic quick connect couplings are required in a multi-coupling. A front loader, for example, may comprise hydraulic lifting cylinders providing a first function and hydraulic tilting cylinders providing a second function. Each function requires two hydraulic lines, one for providing fluid and one for draining fluid. In such case, a multi-coupling for connecting hydraulic lines between the front loader and the vehicle would require four hydraulic couplings.

Many different multi-couplings are available on the market and most of them comprises a first connection plate fixedly attached to the vehicle and a second connection plate attached on the equipment. Multiple guiding pins are typically used to guide the two connection plates into correct position for connection. This is for example shown in EP2360413 A1. A problem with many of the known multi-couplings is the size and complexity of the coupling device. A large and complex coupling device will typically cost more, be more difficult to connect and might take up too much space on the vehicle.

### SUMMARY

Despite known solutions in the field, it would be desirable to develop a hydraulic multi-coupling device and a working vehicle, which overcomes or alleviates at least some of the drawbacks of the prior art.

An object of the present invention is thus to achieve a multi-coupling device for connecting multiple hydraulic lines of a working vehicle and a detachable equipment, which is safe, robust, compact and flexible and which enables easy connection of multiple hydraulic lines.

The herein mentioned objects are achieved by a multi-coupling device and a working vehicle comprising such a multi-coupling device, according to the independent claims.

Hence, according to an aspect of the present invention, a multi-coupling device for connecting multiple hydraulic lines of a working vehicle and a detachable equipment is provided. The multi-coupling device comprises: a first connection plate configured to be fixedly attached to the working vehicle and a second connection plate configured to be attached to the detachable equipment, wherein the first connection plate and the second connection plate comprise at least two corresponding female and male couplings configured to be connected, wherein the multi-coupling device comprises a centrally arranged guiding pin on the first or second connection plate and a corresponding centrally arranged guiding hole in the first or second connection plate for receiving said guiding pin, and wherein the female couplings have an inner conical section for guiding the male couplings.

By using only one centrally located guiding pin as in the multi-coupling device as disclosed herein, connection between the two connection plates will be facilitated. It is much easier to fit only one pin into a corresponding hole compared to using two guiding pins. The connection can thereby be achieved easier and faster. With only one guiding pin, less material is also required and the coupling device can be more compact in shape compared to known coupling devices where at least two guiding pins are used. The centrally arranged guiding pin will safely guide the first and second connection plates into correct position, such that the male and female couplings are aligned to be connected. However, with only one guiding pin there might be rotational movement between the two connection plates, which is undesired. This is handled by means of the inner conical section of the female couplings that will help guiding the male couplings into the female couplings and at the same time prevent or obstruct rotational movement. The multi-coupling device as disclosed herein is thus a compact, cost-efficient and reliable coupling device, which will facilitate connection.

According to another aspect of the present invention, a working vehicle is provided, the working vehicle comprising a multi-coupling device as disclosed herein.

Further objects, advantages and novel features of the present invention will become apparent to one skilled in the art from the following details, and also by putting the invention into practice. Whereas the invention is described below, it should be noted that it is not restricted to the specific details described. Specialists having access to the teachings herein will recognise further applications, modifications and incorporations within other fields, which are within the scope of the invention.

### BRIEF DESCRIPTION OF THE DRAWINGS

For fuller understanding of the present disclosure and further objects and advantages of it, the detailed description set out below should be read together with the accompanying drawings, in which the same reference notations denote similar items in the various drawings, and in which:

FIGS. 1a-b schematically illustrate a multi-coupling device according to examples;

FIG. 1c schematically illustrates a detail of a multi-coupling device according to an example;

FIG. 2 schematically illustrates a multi-coupling device according to an example;

FIGS. 3a-b schematically illustrate a multi-coupling device according to an example;

FIGS. 4a-d schematically illustrate details of a multi-coupling device according to examples;

FIGS. 5a-c schematically illustrate details of a multi-coupling device according to examples;

FIG. 6 schematically illustrates a multi-coupling device according to an example;

FIG. 7 schematically illustrates a working vehicle according to an example;

FIG. 8 schematically illustrates a multi-coupling device according to an example;

FIG. 9 schematically illustrates a multi-coupling device according to an example;

FIGS. 10a-b schematically illustrate a multi-coupling device according to examples; and

FIG. 11 schematically illustrates a multi-coupling device according to an example.

### DETAILED DESCRIPTION

To achieve a compact and cost-efficient multi-coupling device, a multi-coupling device and a working vehicle according to the present disclosure has been developed. The present disclosure is applicable on all sorts of working vehicles, such as construction vehicles, mining vehicles, forestry vehicles, agricultural vehicles or similar.

Hence, according to an aspect of the present invention, a multi-coupling device for connecting multiple hydraulic lines of a working vehicle and a detachable equipment is provided. The multi-coupling device comprises: a first connection plate configured to be fixedly attached to the working vehicle and a second connection plate configured to be attached to the detachable equipment, wherein the first connection plate and the second connection plate comprise at least two corresponding female and male couplings configured to be connected, wherein the multi-coupling device comprises a centrally arranged guiding pin on the first or second connection plate and a corresponding centrally arranged guiding hole in the first or second connection plate for receiving said guiding pin, and wherein the female couplings have an inner conical section for guiding the male couplings.

The inventors have later discovered that the conical sections of the female couplings can facilitate connection of the couplings irrespective of the number and/or position of the guiding pin(s) and guiding hole(s). The inner conical section of the female couplings will help guiding the male couplings into the female couplings and at the same time prevent or obstruct rotational movement. Thus, a single guiding pin could be arranged anywhere on the connection plate and, as long as the female couplings comprises the conical section, connection of the multi-coupling is facilitated. Also, two or more guiding pins could be used and the conical section of the female couplings would still be beneficial. Hence, according to an aspect of the present invention, a multi-coupling device for connecting multiple hydraulic lines of a working vehicle and a detachable equipment is provided, wherein the multi-coupling device comprises: a first connection plate configured to be fixedly attached to the working vehicle and a second connection plate configured to be attached to the detachable equipment, wherein the first connection plate and the second connection plate comprise at least two corresponding female and male couplings configured to be connected, wherein the multi-coupling device comprises a single guiding pin on the first or second connection plate and a single corresponding guiding hole in the first or second connection plate for receiving said guiding pin, and wherein the female couplings have an inner conical section for guiding the male couplings.

It is to be understood that the female couplings may be arranged on the first connection plate or the second connection plate. Similarly, the male couplings may be arranged on the first connection plate or the second connection plate. Each coupling comprises a coupling body. Each coupling body comprises a first portion configured to be connected to a hydraulic line on the working vehicle or the detachable equipment. Each coupling body further comprises a second portion configured to be connected to a second portion of the corresponding female/male coupling. The second portion of the female couplings comprise the inner conical section. It is to be understood that whenever it says “coupling” in this disclosure, it means female or male coupling. Similarly, whenever it says “connection plate”, it means the first connection plate or the second connection plate.

The first connection plate may comprise at least two male couplings extending through the first connection plate, wherein a first portion of each male coupling is configured for connection to a hydraulic line on the working vehicle and a second portion is configured to be connected to the female couplings. The second connection plate may thus comprise at least two female couplings extending through the second connection plate, wherein a first portion of each female coupling is configured for connection to a hydraulic line on the detachable equipment and a second portion is configured to be connected to the second portion of the male couplings.

The detachable equipment, also called implement, may be a front loader, a snow blower or any other equipment that require hydraulic connection with the working vehicle. The second connection plate connected to the equipment will thus be moveable in relation to the first connection plate on the working vehicle. The first connection plate may be referred to as a base plate and the second connection plate may be referred to as a moveable plate. It is to be understood that the multi-coupling device also can be used for hydraulic connection between a tool and the detachable equipment. As an example, the detachable equipment may be a front loader connected to the working vehicle, and the front loader may have a tool such as a bucket, forks or similar, that is hydraulically connected to the front loader by means of a multi-coupling device as disclosed herein. Furthermore, it is to be understood that the multi-coupling also can be used for hydraulic connection between a tool and the working vehicle.

As an example, the first connection plate comprises two, four or six male couplings and the second connection plate comprises two, four or six female couplings, or vice versa. The male couplings and female couplings may be quick connect couplings. The male couplings and female couplings may have a circular cross-section.

The male couplings typically extends through the connection plate, such that the first portion is on a first side of the connection plate and the second portion is on a second, opposite, side of the connection plate. Similarly, the female couplings typically extends through the connection plate, such that the first portion is on a first side of the connection plate and the second portion is on a second, opposite, side of the connection plate. The first connection plate and the second connection plate are thus configured to be arranged with the second side of the first connection plate facing the second side of the second connection plate.

The first connection plate is suitably attached to the working vehicle by means of fasteners connected to a bracket or similar on the working vehicle. The first connection plate may thus comprise apertures for insertion of fasteners. The first connection plate may be attached to the working vehicle with the second side facing upwards and the first side facing downwards. When the second connection plate is connected to the first connection plate, the second side of the second connection plate typically faces downwards.

The guiding pin may be centrally arranged on the first connection plate or on the second connection plate. Typically, the guiding pin extends from the second side of the connection plate in direction away from the connection plate. The guiding pin extends beyond the female couplings in the event that it is arranged on the second connection plate and similarly extends beyond the male couplings when it is arranged on the first connection plate. The guiding hole may be provided with a guiding sleeve arranged around the guiding hole on the second side of the connection plate. This way, a larger guiding surface is achieved. The guiding pin is suitably at least partly inserted through an aperture in the connection plate to which it is attached. The guiding pin may be attached to the connection plate by means of plastic deformation. In such case, the guiding pin comprises a recessed top portion and a stop portion. The stop portion may have a larger diameter than the rest of the guiding pin. The guiding pin is inserted through the aperture in the connection plate, such that the stop portion abuts one side (second side) of the connection plate and the recessed top portion is on the other side (first side) of the connection plate. The top portion of the guiding pin is subsequently plastically deformed by the means of pressing, rolling or similar, the recessed top portion towards the first side of the connection plate, and thus clamping the guiding pin to the connection plate by means of the deformed top portion and the stop portion. Alternatively, the guiding pin is attached to the connection plate by means of interference fit/press fit, welding or by using fastener(s).

According to an example of the present disclosure, the second portion of the male couplings comprises a conical base corresponding to the inner conical section of the female couplings. This way, a tight connection is achieved between the corresponding male and female coupling. The male couplings may have a conical base closest to the connection plate on which it is arranged and a cylindrical upper portion. The conical base may taper in direction away from the connection plate. The inner conical section of the female couplings may be tapering in an inward direction. Thus, the diameter of the female couplings may be larger at the outer end of the coupling and decrease inwards. Typically, the conical section of the female couplings transitions into a cylindrical section corresponding to the cylindrical portion of the male couplings.

The female couplings and the male couplings are advantageously symmetrically arranged around the guiding pin respectively the guiding hole. Thus, the guiding pin and guiding hole being centrally arranged means that they are centred in relation to the female/male couplings. For example, in the event that the multi-coupling device comprises four couplings, the couplings are typically arranged two in a row and the guiding pin/hole is arranged in the centre at equal distance from all four couplings. In the event that the multi-coupling device comprises two couplings, the guiding pin/hole may be arranged between the two couplings. Alternatively, the guiding pin and the guiding hole are centrally arranged in relation to the connection plate on which they are attached.

According to an aspect of the present disclosure, the multi-coupling device further comprises a connection bracket pivotally attached to the first connection plate or the second connection plate, the bracket comprising two cam portions arranged on opposite sides of the connection plate, wherein each cam portion comprises an eccentric slot configured to receive a holding element of the other connection plate, such that when the connection bracket is pivoted from an open position towards a closed position, the first connection plate and the second connection plate are moved closer to each other and ultimately held together. In some applications, it is advantageous to have the connection bracket on the first connection plate, for example to reduce weight and size of the second connection plate on the detachable equipment. In other applications, it is advantageous to have the connection bracket on the second connection plate, for example to save space on the working vehicle. The cam portions of the connection bracket are connected by an intermediate section. The intermediate section is essentially horizontally arranged. The intermediate section extends in parallel with the pivot axis around which the connection bracket pivots. Each cam portion is pivotally connected to the connection plate by means of a fastener. The cam portions are parallel with each other and are attached to the connection plate, such that the attachment points (pivot points) of the cam portions are axially aligned. In commonly known multi-coupling devices, the cam portions are sometimes pivotally arranged by means of an internal pivot shaft extending through the connection plate. This will restrict the possibility to arrange couplings or guiding pins/holes where the pivot shaft extends. By using fasteners, and not using a pivot shaft, for pivoting the connection bracket, an increased flexibility is achieved and couplings and guiding pins/holes can be arranged in a compact and space-saving way.

The holding elements may be arranged on the first connection plate or the second connection plate. Thus, one connection plate comprises the holding elements and the other comprises the connection bracket. The holding elements are typically arranged, such that they are aligned with the guiding pin/guiding hole. The holding elements may be fixed elements configured to slide in the eccentric slots or they may be rotatable elements configured to rotate in the eccentric slots.

Each holding element may comprise a screw with a cylindrical support section and a threaded section. The cylindrical support section has a larger diameter than the threaded section. The screw also comprises a head section at one end of the support section. The cam portions of the connection bracket are arranged to rotate around the cylindrical support section of each holding element. In order for the cam portions to rotate smoothly, radial play is required with regard to the cylindrical support section around which it will rotate. Each cam portion will, during connection, be positioned between the connection plate on which the holding elements are arranged and the head section of the holding element.

Thus, axial play is also required with regard to said connection plate and the head section of the holding element. When radial forces are applied on the holding element by means of the rotating cam portion, the radial play could cause the holding element (screw) to bend. To withstand the radial forces, the holding element therefore comprises a conical section between the cylindrical support section and the threaded section. The conical section is tapering from the support section towards the threaded section. The holding element is suitably connected to the connection plate, such that the conical section and the threaded section are inside the connection plate, and at least a part of the support section and the head section are outside the connection plate. The connection plate comprises correspondingly shaped threaded holes for receiving the holding elements and engaging with the threaded section of the holding elements. Said holes in the connection plate each comprises a countersink and the conical section of the holding element is configured to abut inner walls of said countersink. This way, the conical section will act as mechanical stop and support within the connection plate, and there will be no bending stress on the threaded section. Similar screws with a head section, cylindrical support section, a conical section and a threaded section could also be used for attaching the cam portions of the connection bracket to the connection plate on which it is arranged. Prior art typically solves the problem with bending stress by using longer screws. The conical section of the screw according to this disclosure allows a shorter part of the screw to be inserted inside the connection plate. The part of the screw that is inserted into the connection plate can thus be shorter but still withstand the radial forces. This is specifically advantageous in the present multi-coupling device since the screws for attaching the cam portions, and the holding elements, typically are arranged aligned with the guiding pin and/or guiding hole, which thereby limits the possible length of the screws within the connection plate.

The first or second connection plate may comprise two holding elements arranged on opposite sides of the connection plate. During connection of the multi-coupling device, the holding elements will move inside the eccentric slots of the respective cam portion and the first and second connection plates are thereby moved tighter against each other. In the open position of the connection bracket, the cam portions are arranged with the opening of the eccentric slots facing in the direction of the second portion of the couplings on the connection plate. When connecting the second connection plate with the first connection plate, the connection bracket is typically in its open position and the second connection plate is moved into a position above the first connection plate. Subsequently, the second connection plate is lowered, such that the guiding pin is inserted into the guiding hole and the opening of the eccentric slots is aligned with the holding elements. The connection bracket is then pivoted to the closed position, wherein the holding elements moves in the eccentric slots, the first and second connection plates are moved closer to each other and the female couplings and the male couplings are ultimately connected. The connection bracket may be pushed downwards, to pivot it to the closed position.

In another example, the multi-coupling device comprises a manoeuvring lever removably attached to one side of the connection bracket. The manoeuvring lever may be attached to the connection bracket by means of fasteners. The manoeuvring lever will facilitate pivoting of the connection bracket. The manoeuvring lever may also be referred to as a handle and can be arranged on either side of the connection bracket in association with one of the cam portions. By using a manoeuvring lever that is separate from the connection bracket, it can easily be mounted on either side of the connection bracket, which increases flexibility. In some applications, it may be advantageous to have the manoeuvring lever on a specific side of the connection plate to fit better on the working vehicle/detachable equipment or to reduce impact on the space on the working vehicle. To be able to remove the manoeuvring lever is also advantageous for maintenance purposes. The manoeuvring lever is typically configured as an essentially straight, elongated arm. By means of having the manoeuvring lever and connection bracket on the second connection plate, the second connection plate will be easier to grip and position correctly for connection with the first connection plate.

The connection bracket may be formed by bending a metal sheet with identically shaped cam portions at each end. This way, the connection bracket will be easy and cost-efficient to manufacture. The cam portions of the connection bracket may be configured, such that the outer edge of the cam portions constitute an integrated bending reference plane for facilitating the bending. As a result, bending can be performed at predetermined distance from the outer edge of the cam portions and at a predetermined angle. This way, it is ensured that the pivot points of the cam portions are aligned and that a sufficient production capability can be achieved also with basic bending equipment. The bent connection bracket will at least partly surround the connection plate. The connection bracket is essentially U-shaped.

According to one aspect of the present disclosure, the multi-coupling device further comprises a safety mechanism for locking the position of the connection bracket in relation to the connection plate on which it is arranged, the safety mechanism comprising a spring loaded locking element removably attached to the connection plate on which the connection bracket is arranged. The locking element may be arranged to interact with any one of the cam portions of the connection bracket and thereby lock the position of the connection bracket about the pivot axis. The safety mechanism will this way enable locking of the connection bracket in the closed position, such that connection is maintained between the female and male couplings. Also, by locking the position of the connection bracket in the closed position, it is prevented that the second connection plate is completely disconnection from the first connection plate and cause personal damage. By having a locking element that is removably attached to the connection plate, flexibility increases. The locking element according to this disclosure is not an integral part of any of the connection plates and is thus less complex and easier to manufacture and to replace in case of wear/damages or other problems. Furthermore, the locking element can be arranged on either side of the connection plate, which could be advantageous depending on the working vehicle and/or detachable equipment. In one example, the safety mechanism comprises two locking elements, one arranged on each side of the connection plate. The locking element may be spring loaded by means of a spring element connected to the locking element and the connection plate.

The locking element may be pivotally attached to the connection plate. The locking element may pivot about a pivot axis parallel with the pivot axis of the connection bracket.

The locking element may comprise a hook portion configured to engage with at least one correspondingly shaped peripheral recess on one of the cam portions of the connection bracket. When the hook portion of the locking element is engaged with the peripheral recess of the cam portion, the locking element will mechanically prevent the cam portion, and thus the connection bracket, from pivoting in any direction. The peripheral recess may be arranged on the cam portion, such that it engages with the locking element and locks the connection bracket in the closed position. In one example, the cam portion comprises a first peripheral recess for locking the connection bracket in the closed position, and a second peripheral recess for locking the connection bracket in the open position. By being able to lock the connection bracket in the open position, connection between the first connection plate and the second connection plate is facilitated. When the connection bracket is locked in the open position, the operator does not have to have a hand on the connection bracket during connection, instead focus can be on positioning the second connection plate correctly in relation to the first connection plate. The second peripheral recess is typically arranged closer to the intermediate section than the first peripheral recess is.

According to an example, the safety mechanism comprises a torsion spring arranged around a pivot shaft on which the locking element is arranged, and connected to the locking element and the connection plate. The spring element biasing the locking element may thus be a torsion spring, specifically a helical torsion spring. The torsion spring will exert a torque on the pivot shaft to pivot the locking element towards the cam portion. This way, the hook portion of the locking element will be retained in the corresponding recess in the cam portion. By applying a manual force on the locking element, the locking element can be pivoted in a direction away from the cam portion and thereby disengage the hook portion and the peripheral recess. The cam portion and thus the connection bracket will this way be able to pivot. The locking element may comprise a manoeuver portion for easy handling/pivoting of the locking element.

In another example of the present disclosure, the locking element of the safety mechanism is configured as a rocker arm pivotally attached to the connection plate. The locking element comprises a front portion (with the hook portion) extending from the pivot shaft towards the cam portion, and a rear portion extending from the pivot shaft away from the cam portion. The spring element may be a coil spring arranged in connection with the rear portion and the connection plate, underneath the rear portion. The coil spring will apply a spring force upwards on the rear portion and thereby pivot the locking element towards the cam portion. The hook portion will thereby be retained in the peripheral recess. To release the cam portion and enable pivoting of the connection bracket, the locking element will have to be pivoted in an opposite direction and thereby press the rear portion of the locking element downwards against the spring. The spring will thereby be compressed and the hook portion of the locking element will disengage the peripheral recess.

According to an aspect of the present disclosure, the multi-coupling device further comprises individual coupling covers for the first connection plate, each coupling cover comprising a hood configured to cover the second portion of the coupling, a retaining portion connected to the first portion of the same coupling and a strap connecting the hood and the retaining portion. The hood will cover the coupling and protect it from dirt, water etc. The retaining portion will ensure that the coupling cover is connected to the coupling even when the first connection plate is connected to the second connection plate and the hood thus not covers the coupling. By having the retaining portion connected to the first portion of the coupling, on the underside of the first connection plate, the retaining portion will not interfere with the connection between the female/male couplings. The coupling covers may comprise a rubber or silicone material. The retaining portion may be annular shaped and be configured to be arranged around the first portion of the couplings. The hoods may also be referred to as bonnets. The hoods may be cylindrically shaped with a closed top. The strap may be a metal wire, tube, string or similar.

The first connection plate may comprise a groove at a first end of the first connection plate, wherein the straps of the individual coupling covers extends through the groove. The groove in the first connection plate will facilitate having the retaining portion connected to the first portion of the couplings whereby the straps will extend from one side of the first connection plate to the other. The groove will accommodate a part of the straps, such that the straps essentially do not extend outside the circumference of the first connection plate.

According to an example of the present disclosure, the multi-coupling device, further comprises a housing at least partly covering the second connection plate, the housing having opposite side walls extending beyond the second connection plate in direction of the second portion of the couplings, such that the side walls obstruct insertion of an object through the eccentric slot when the connection bracket is in the open position. The housing will laterally cover at least a part of the gap between the first connection plate and the second connection plate during connection of the multi-coupling device. The housing will also prevent larger items/dirt from entering between the first connection plate and the second connection plate when they are connected. This is very advantageous considering that the multi-coupling device often is arranged in vicinity of the wheels of the working vehicle.

The multi-coupling device may further comprise an electrical connection for connecting at least one electrical line between the working vehicle and the equipment, the electrical connection comprising corresponding electric connectors arranged on the first connection plate and the second connection plate. The exact configuration of the electric connectors is not of importance for the invention. The electric connections can be configured in different ways and have different shapes. The cross-sectional shape of the electric connectors may for example be circular, square-shaped or rectangular. The electric connectors may be arranged on the respective connection plate, such that the electric connectors are furthest away from the intermediate section of the connection bracket. Alternatively, the electric connectors may form part of the guiding pin/guiding hole, or one of the couplings may be exchanged to an electric connector.

As previously mentioned, the multi-coupling device can also be used for hydraulic connection between a tool and the detachable equipment. Thus, according to an aspect of the present invention, a multi-coupling device for connecting multiple hydraulic lines of a detachable equipment of a working vehicle and a tool connected to the detachable equipment is provided. The multi-coupling device comprises: a first connection plate configured to be fixedly attached to the detachable equipment and a second connection plate configured to be attached to the tool, wherein the first connection plate and the second connection plate comprise at least two corresponding female and male couplings configured to be connected, wherein the multi-coupling device comprises a centrally arranged guiding pin on the first or second connection plate and a corresponding centrally arranged guiding hole in the first or second connection plate for receiving said guiding pin, and wherein the female couplings have an inner conical section for guiding the male couplings.

In an alternative example, the guiding pin is not necessarily centrally arranged but the multi-coupling device comprises a single guiding pin on the first or second connection plate and a single corresponding guiding hole in the first or second connection plate for receiving said guiding pin, and wherein the female couplings have an inner conical section for guiding the male couplings.

It is to be understood that all features and advantages as discussed with regard to the multi-coupling device being used between the working vehicle and the detachable equipment are also applicable on the aspect where the multi-coupling device is used between the detachable equipment and the tool.

Using a multi-coupling device as disclosed herein for the hydraulic connection between a detachable equipment of a working vehicle and the tool is very advantageous since the tool often is exchanged on a working vehicle. A working vehicle may comprise one detachable equipment, such as a front loader, and a plurality of tools, such as buckets, manure and silage tools, lifting tools, bale handling tools etc. Having a quick and easy multi-coupling for the hydraulic coupling will thus facilitate the mounting of the tool on the detachable equipment.

In one example, the first connection plate on the detachable equipment comprises the male couplings and the second connection plate on the tool comprises the female couplings. The first connection plate may further comprise the guiding hole and the holding elements. The connection bracket with the manoeuvring lever may be arranged on the second connection plate.

The first connection plate may be attached to a tool carrier of the detachable equipment. Specifically, the first connection plate may be attached to a coupling bracket of the tool carrier. The first connection plate with the male couplings may be arranged on the coupling bracket, such that the first portion of the male couplings extends through coupling openings in the coupling bracket and the first connection plate rests on the coupling bracket. The guiding hole may comprise a guiding sleeve extending on both sides of the first connection plate. The part of the guiding sleeve extending on the same side as the first portion of the male couplings, may extend through guiding holes in the coupling bracket. The second connection plate is subsequently mounted from above.

In one example, the multi-coupling device comprises at least one circlip ring for attachment to the tool carrier. Typically, the multi-coupling device comprises at least one circlip ring per coupling on the first connection plate. In one example, each coupling on the first connection plate comprises a circlip ring arranged around the coupling body, clamped between the first portion of the coupling and the coupling bracket. Alternatively or additionally, each coupling on the first connection plate may comprise a circlip ring arranged around the coupling body, clamped between the first connection plate and the coupling bracket. Known solutions for hydraulic coupling typically involves attaching individual quick couplings to the coupling bracket of the tool carrier by means of bolts and a counter nut, restricting the movement of the coupling both axially and rotationally. Other solutions for multi-couplings involves a connection plate being attached to the coupling bracket with screws and nuts. By using circlip rings, axial movement of the first connection plate in relation to the coupling bracket is prevented but rotational or swiveling movement of the couplings and thus the first connection plate is enabled. This way, connecting hydraulic lines to the first portions of the couplings will be facilitated. Also, hydraulic lines connected to a swiveling coupling will be more relaxed when the tool carrier is moved in relation to the detachable equipment. It is to be understood that even if the circlip rings are described herein in relation to the multi-coupling device being used for connection between a detachable equipment and a tool, circlip rings could be used also for attaching the first connection plate to a coupling bracket of the working vehicle.

In one example, the first connection plate is an integrated part of the tool carrier. Typically, the first connection plate is integrated in the coupling bracket of the tool carrier. The first connection plate may thus be part of the connection bracket. In such event, the multi-coupling device may comprise circlip rings arranged around the coupling bodies, clamped between the first portion of the couplings and the first connection plate/coupling bracket.

According to another aspect of the present disclosure, a working vehicle with a detachable equipment and a tool is provided, the working vehicle comprising a multi-coupling device as disclosed herein. The working vehicle may be a construction vehicle, a tractor, a mining vehicle, a forestry vehicle, an agriculture vehicle or similar.

The present disclosure will now be further illustrated with reference to the appended figures.

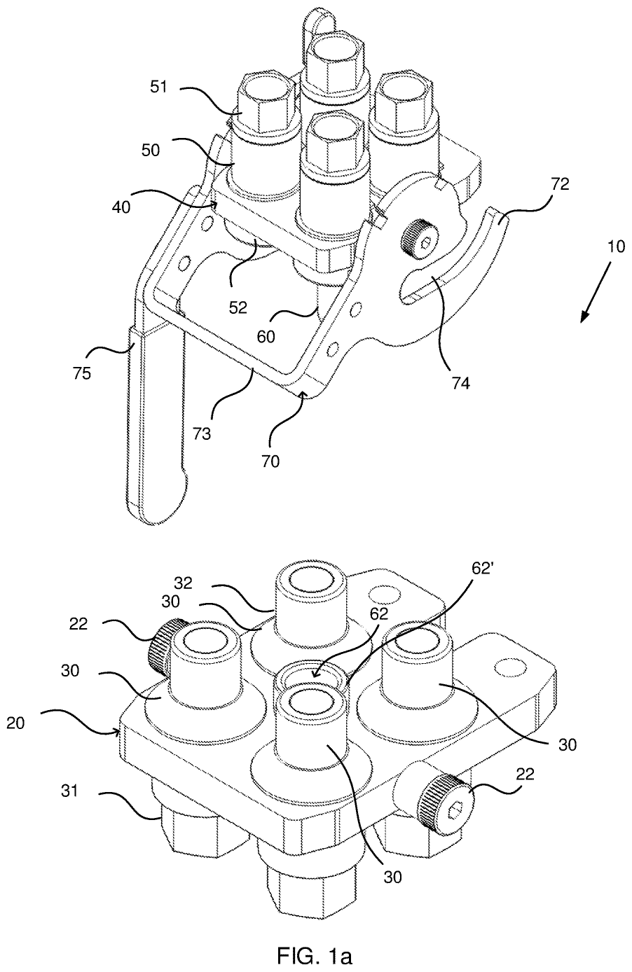

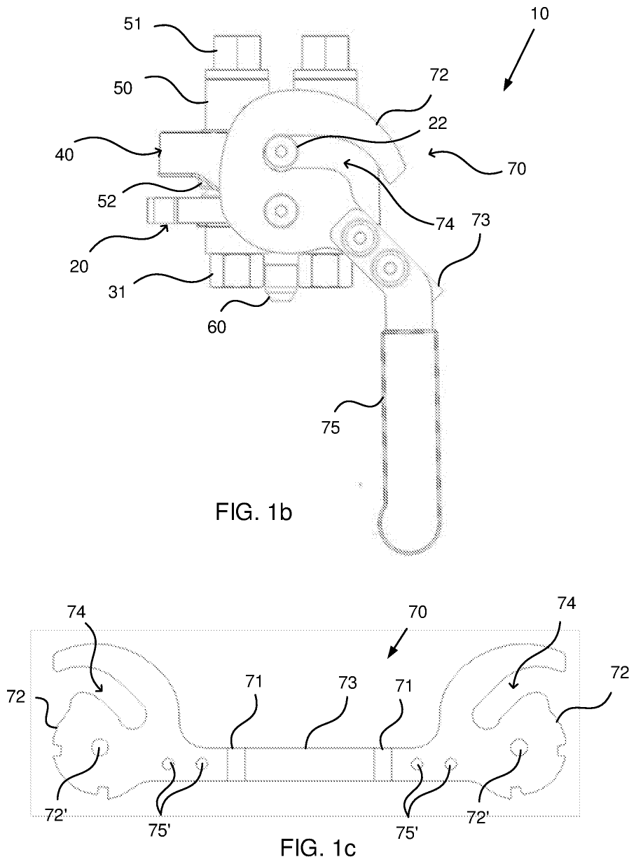

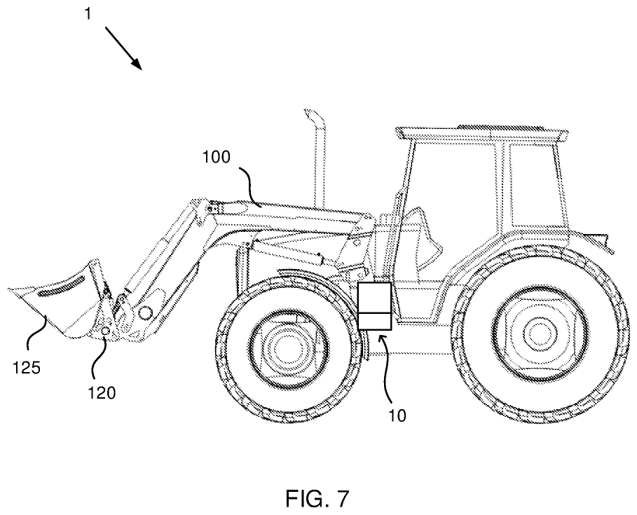

FIG. 1a schematically illustrates a multi-coupling device 10 for connecting multiple hydraulic lines of a working vehicle and a detachable equipment (see FIG. 7) according to an example. The multi-coupling device 10 comprises: a first connection plate 20 configured to be fixedly attached to the working vehicle and second connection plate 40 configured to be moveably attached to the detachable equipment.

In this example, the first connection plate 20 comprises four male couplings 30 extending through the first connection plate 20. The second connection plate 40 comprises four female couplings 50 extending through the second connection plate 40. A first portion 31 of each male coupling 30 is configured for connection to a hydraulic line on the working vehicle and a first portion 51 of each female coupling is configured to connection to a hydraulic line on the detachable equipment. A second portion 32 of each male coupling 30 is configured to be connected to a corresponding second portion 52 of a female coupling on the second connection plate 40. The first portions 31 of the male couplings 30 are arranged on one side of the first connection plate 20 and the second portion 32 of the male couplings 30 are arranged on the other opposite side of the first connection plate 20. Similarly, the first portions 51 of the female couplings 50 are arranged on one side of the second connection plate 40 and the second portion 52 of the female couplings 50 are arranged on the other opposite side of the second connection plate 40. As illustrated in the figure, the first connection plate 20 and the second connection plate 40 are configured to be arranged in relation to each other, such that the second portion 32 of the male couplings 30 faces the second portion 52 of the female couplings 50.

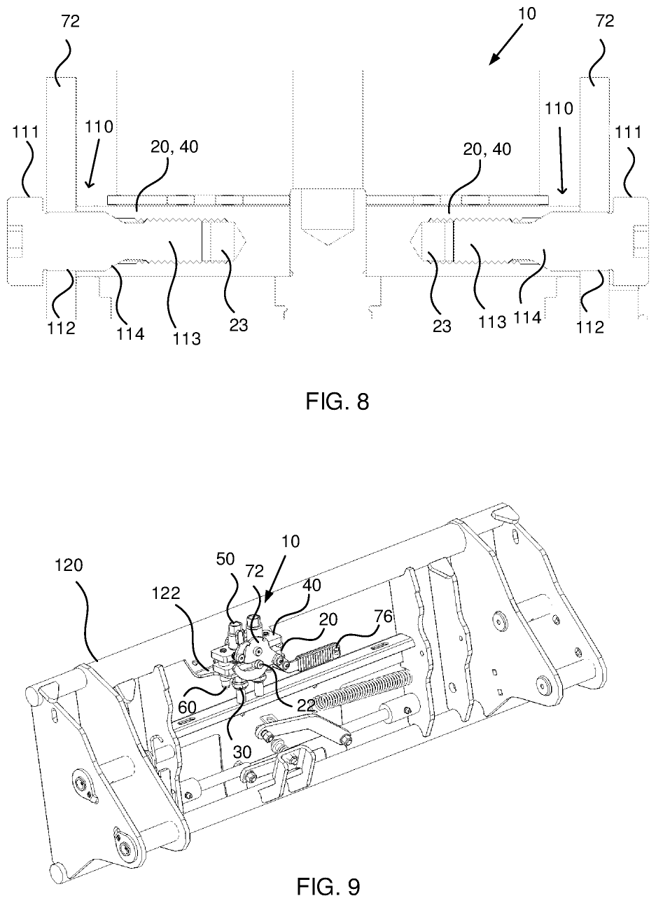

The second connection plate 40 comprises a centrally arranged guiding pin 60 extending downwards, in the same direction as the second portions 52 of the female couplings 50. The first connection plate 20 comprises a corresponding guiding hole 62 with a guiding sleeve 62′ for receiving said guiding pin 60. The first connection plate 20 further comprises two holding elements 22, arranged on opposite sides of the first connection plate. The holding elements 22 may each comprise a screw 110 as disclosed in FIG. 8

The multi-coupling device 10 further comprises a connection bracket 70 pivotally attached to the second connection plate 40. The connection bracket 70 is essentially U-shaped and comprises two parallel cam portions 72 arranged on opposite sides of the second connection plate 40 and an intermediate section 73 connecting the cam portions 72. Each cam portion 72 comprises an eccentric slot 74 configured to receive the holding elements 22 of the first connection plate 20 during connection of the first and second connection plates 20, 40.

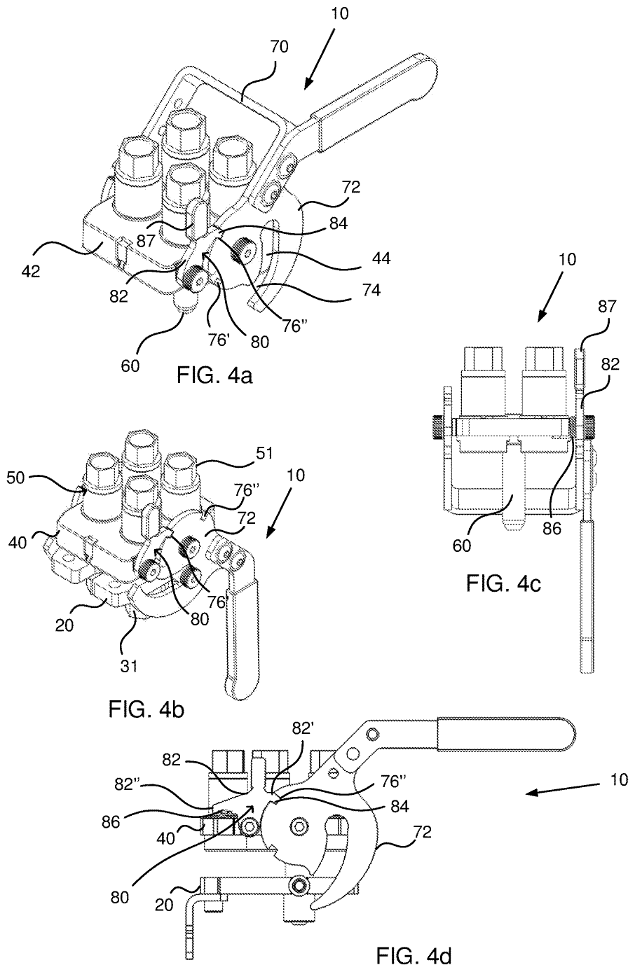

The connection bracket 70 can be pivoted between a closed position and an open position. This is further illustrated in FIGS. 4a-c. The connection bracket 70 should be in the open position when initiating the connection between the first and the second connection plates 20, 40. The multi-coupling device 10 in this figure further comprises a manoeuvring lever 75 removably attached to one side of the connection bracket 70. The manoeuvring lever 75 will facilitate pivoting of the connection bracket 70.

FIG. 1b schematically illustrates a multi-coupling device 10 for connecting multiple hydraulic lines of a working vehicle 1 and a detachable equipment 100 according to an example. The multi-coupling 10 may be configured as in FIG. 1a but in this example, the first connection plate 20 comprises the connection bracket 70 and the second connection plate 40 comprises the holding elements 22.

FIG. 1c schematically illustrates a connection bracket 70 of a multi-coupling device 10 according to an example. The multi-coupling 10 may be configured as in FIG. 1a or 1b. FIG. 1c shows the connection bracket 70 before being formed into an essentially U-shaped configuration. The connection bracket 70 is thus made from an elongated metal sheet with identically shaped cam portions 72 at each end. The cam portions 72 are connected by the intermediate section 73. Each cam portion 72 has a pivot point 72′ and attachment points 75′ for the manoeuvring lever 75. The cam portions 72 may be configured, such that the outer edge of the cam portions 72 constitute a bending reference plane for facilitating the bending. The bending sections 71 where the sheet metal is bent into a correct shape are also shown in the figure.

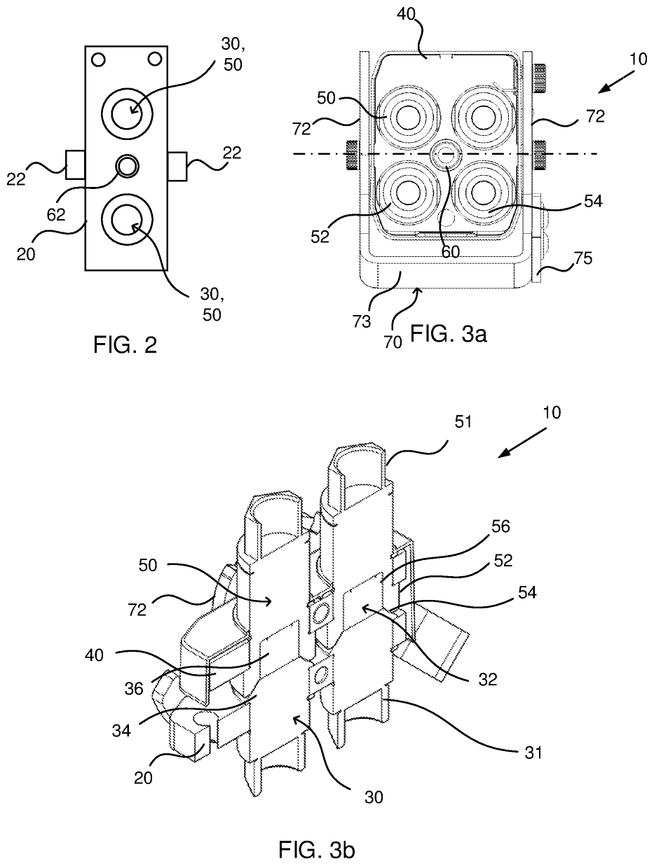

FIG. 2 schematically illustrates a first connection plate 20 of a multi-coupling device 10 according to an example. The multi-coupling device 10 may be configured as in FIG. 1a but in this example, the first connection plate 20 comprises two couplings 30, 50. The guiding hole 62 is centrally arranged between the couplings 30, 50.

FIG. 3a schematically illustrates a multi-coupling device 10 according to an example. The multi-coupling device 10 may be configured as disclosed in FIG. 1a. FIG. 3a shows a bottom view of the second connection plate 40 and how the guiding pin 60 is arranged centrally in relation to the female couplings 50 (only the second portion 52 of the female couplings 50 are shown here). The guiding pin 60 is arranged at equal distance from the female couplings 50. Thus, the female couplings 50 are symmetrically arranged about the guiding pin 60. The second portion 52 of the female couplings 50 each has an inner conical section 54 for guiding the second portion 32 of the male couplings 30.

This figure also shows that each cam portion 72 of the connection bracket 70 is pivotally connected to the second connection plate 40 by means of a fastener, such as a screw, bolt or similar. The cam portions 72 may be attached to the second connection plate 40 by means of a screw 110 as disclosed in FIG. 8. The cam portions 72 are attached to the second connection plate 40, such that the attachment points of the cam portions 72 are axially aligned.

FIG. 3b schematically illustrates a cross-sectional view of a multi-coupling device 10 according to an example. The multi-coupling device 10 may be configured as disclosed in FIG. 1a or FIG. 3a. In this figure, the first connection plate 20 and the second connection plate 40 are connected and the male couplings 30 and the female couplings 50 are connected. As also described in FIG. 3a, the second portion 52 of the female couplings 50 comprises an inner conical section 54. The inner conical section 54 of the female couplings 50 is tapering in an inward direction. Thus, the diameter of the second portion 52 of the female couplings 50 is larger at the outer end of the coupling and decreases inwardly. The conical section 54 of the female couplings 50 transitions into an inner cylindrical section 56 corresponding to a cylindrical portion 36 of the second portion 32 of the male couplings 30.

In order to achieve a tight connection between the female coupling 50 and the male coupling 30, the male couplings 30 comprises a conical base 34 corresponding to the conical section 54 of the female couplings 50. The conical base 34 of the male couplings 30 is arranged closest to the first connection plate 20. The conical base 34 tapers upwards, away from the first connection plate 20.

FIGS. 4a-d schematically illustrate a multi-coupling device 10 according to examples. The multi-coupling device 10 may be configured as disclosed in FIG. 1, 2 or 3. These figures show the multi-coupling device 10 further comprising a safety mechanism 80 for locking the position of the connection bracket 70 in relation to the second connection plate 40. The connection bracket 70 can be pivoted between an open position and a closed position. FIG. 4a shows the connection bracket 70 in the open position and FIGS. 4b and 4c show the connection bracket 70 in the closed position.

The safety mechanism 80 comprises a spring loaded locking element 82 removably attached to the second connection plate 40 in association with one of the cam portions 72 of the connection bracket 70. The locking element 82 is arranged to interact with one of the cam portions 72 of the connection bracket 70 and thereby lock the position of the connection bracket 70 about the pivot axis. The locking element 82 is spring loaded by means of a spring element 86 connected to the locking element 82 and the second connection plate 40. The locking element 82 is pivotally attached to the second connection plate 40 and pivots about a pivot axis parallel with the pivot axis of the connection bracket 70.

The locking element 82 comprises a hook portion 84 configured to engage with at least one correspondingly shaped peripheral recess 76, 76′, 76″ on one of the cam portions 72 of the connection bracket 70. In this example, the safety mechanism 80 comprises two peripheral recesses 76′, 76″ on the cam portion 72, one 76″ for locking the connection bracket 70 in the open position (shown in FIG. 4a) and one 76′ for locking the connection bracket 70 in the closed position (shown in FIG. 4b). When the hook portion 84 of the locking element 82 is engaged with the peripheral recess 76′, 76″ of the cam portion 72, the locking element 82 will mechanically prevent the cam portion 72, and thus the connection bracket 70, from pivoting in any direction.

As shown in FIG. 4a, the connection bracket 70 in the open position will have the cam portions 72 positioned with the opening of the eccentric slot 74 facing downwards towards the first connection plate 20. When connecting the second connection plate 40 with the first connection plate 20 (as shown in FIG. 4b), the connection bracket 70 is first in its open position and the second connection plate 40 is moved into a position above the first connection plate 20. Subsequently, the second connection plate 40 is lowered, such that the guiding pin 60 is inserted into the guiding hole 62 and the openings of the eccentric slots 74 are aligned with the holding elements 22 of the first connection plate 20. The connection bracket 70 is then pivoted to the closed position, wherein the holding elements 22 are moved in the eccentric slots 74 whereby the first connection plate 20 and the second connection plate 40 are pressed together and the male and female couplings 30, 50 are connected.

FIG. 4a also shows the multi-coupling device 10 comprising a housing 42 at least partly covering the second connection plate 40. The housing 42 may be made of plastics. The housing 42 has opposite side walls 44 in association with the cam portions 72 of the connection bracket 70. The side walls 44 extend beyond the second connection plate 40 in direction of the second portion 52 of the female couplings 50. This way, the side walls 44 obstruct insertion of an object through the eccentric slot 74 when the connection bracket 70 is in the open position.

FIG. 4c shows the multi-coupling device 10 where the safety mechanism 80 comprises a torsion spring 86 arranged around a pivot shaft on which the locking element 82 is arranged. The torsion spring 86 is connected to the locking element 82 and the second connection plate 40. The torsion spring 86 will exert a torque on the pivot shaft to pivot the locking element 82 towards the cam portion 72. The locking element 82 may comprise a manoeuver portion 87 for easy handling/pivoting of the locking element 82.

FIG. 4d shows another example of the safety mechanism 80, where the locking element 82 is configured as a rocker arm pivotally attached to the second connection plate 40. The locking element 82 comprises a front portion 82′ with the hook portion 84 extending from the pivot shaft towards the cam portion 72, and a rear portion 82″ extending from the pivot shaft away from the cam portion 72. The spring element 86 may be a coil spring arranged in connection with the rear portion 82″ and the second connection plate 40, underneath the rear portion 82″. The coil spring will apply a spring force upwards on the rear portion 82″ and thereby pivot the locking element 82 towards the cam portion 72. In this figure, the connection bracket 70 is locked in the open position.

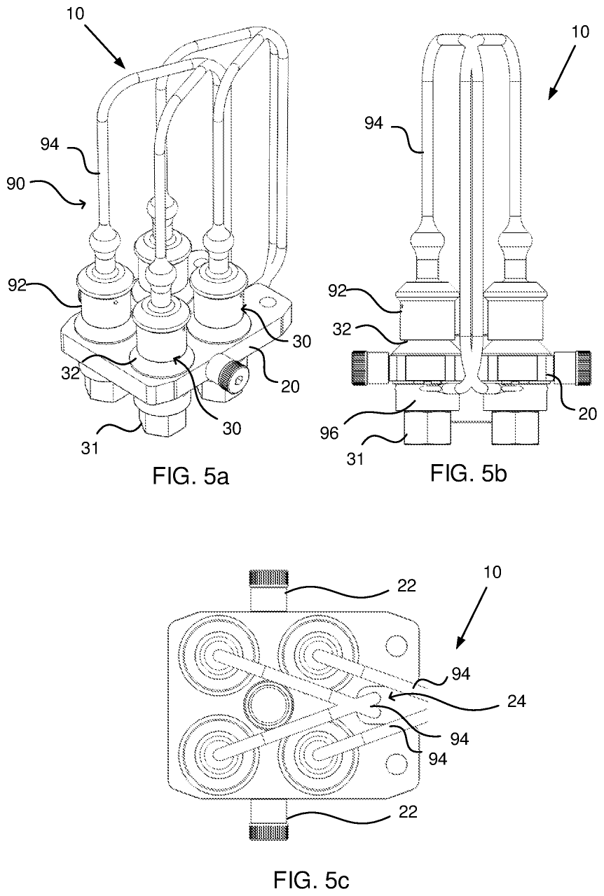

FIGS. 5a-c schematically illustrate a multi-coupling device 10 according to examples. The multi-coupling device 10 may be configured as disclosed in FIG. 1a-b, 2, 3a-b or 4a-d. These figures show the multi-coupling device 10 further comprising individual coupling covers 90 for the first connection plate 20. Each coupling cover 90 comprises a hood 92 configured to cover the second portion 32 of the male coupling 30, a retaining portion 96 connected to the first portion 31 of the same male coupling 30 and a strap 94 connecting the hood 92 and the retaining portion 96. The hood 92 covers the male coupling 30 when it is not used, and protects it from dirt, water etc. The retaining portion 96 will ensure that the coupling cover 90 is connected to the male coupling 30 when not being used to cover the couplings 30. The coupling covers 90 may comprise a rubber or silicone material. The retaining portion 96 is annular shaped and is arranged around the first portion 31 of the male couplings 30.

In FIG. 5c is disclosed a groove 24 in the first connection plate 20. The groove 24 is arranged to allow the straps 94 of the coupling covers 90 to extend there through. The groove 24 will this way facilitate having the retaining portion 96 connected to the male couplings 30 on one side of the first connection plate 20 and the hoods 92 on the other side of the first connection plate 20.

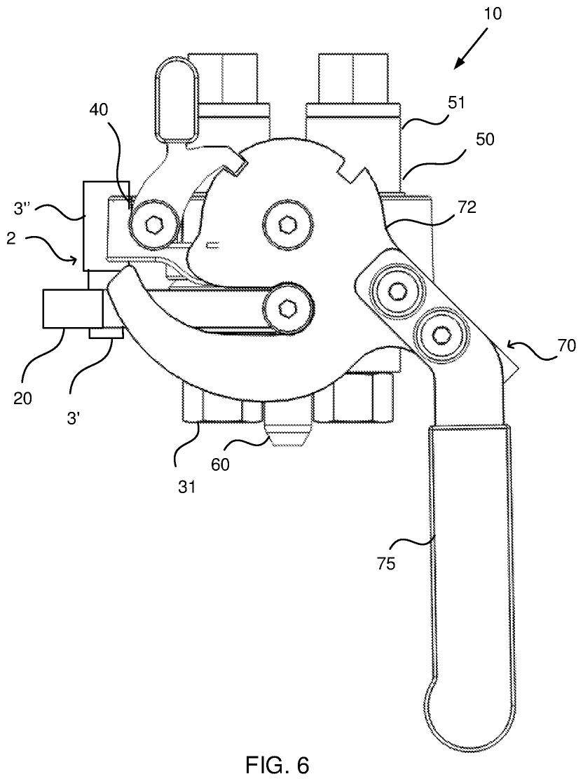

FIG. 6 schematically illustrates a multi-coupling device 10 according to an example. The multi-coupling device 10 may be configured as disclosed in FIG. 1a-b, 2, 3a-b, 4a-d or 5a-c. In this example, the multi-coupling device 10 further comprises an electrical connection 2 for connecting at least one electrical line between the working vehicle 1 and the equipment 100. The electrical connection 2 comprises corresponding electric connectors 3′, 3″ arranged on the first connection plate 20 and the second connection plate 40.

FIG. 7 schematically illustrates a working vehicle 1 according to an example. The working vehicle 1 comprises a detachable equipment 100 in the form of a front loader. The working vehicle 1 may be a construction vehicle, a tractor, a mining vehicle, a forestry vehicle, an agriculture vehicle or similar. The front loader 100 is attached to the front of the working vehicle 1 and is hydraulically connected to the working vehicle 1 by means of a multi-coupling device 10 as disclosed in any of FIG. 1-6 or 9-11. The front loader 100 typically comprises a tool carrier 120 removably connected to a tool 125, such as a bucket. The tool 125 may be hydraulically connected to the tool carrier 120 by means of a multi-coupling 10 device as disclosed in any of FIG. 1-6 or 9-11.

FIG. 8 schematically illustrates a multi-coupling device 10 according to an example. The multi-coupling device 10 may be configured as disclosed in any of the FIGS. 1-6, 9-11. In this example, the multi-coupling device 10 comprises at least one screw 110. The screw 110 may constitute the holding element 22 as shown in previous figures or it might constitute the fastener used for attaching a cam portion 72 of the connection bracket 70 to the connection plate 20, 40. The screw 110 comprises a head section 111, a cylindrical support section 112 and a threaded section 113. The cylindrical support section 112 has a larger diameter than the threaded section 113. The screw 110 further comprises a conical section 114 between the support section 112 and the threaded section 113. The conical section 114 is tapering from the support section 112 towards the threaded section 113. The screw 110 is configured to be arranged with the head section 111 and at least a part of the cylindrical support section 112 outside the connection plate 20, 40 and the conical section 114 and the threaded section 113 inserted within the connection plate 20, 40. The cam portions 72 of the connection bracket 70 are configured to rotate or pivot around the cylindrical support section 112 of the screw 110.

The connection plate 20, 40 comprises correspondingly shaped threaded holes 23 for receiving the screws 110 and engage with the threaded section 113. Each hole 23 for the screws comprises a countersink, wherein the conical section 114 of the screw 110 is configured to abut the inner walls of said countersink. This way, the conical section 114 will act as mechanical stop and support within the connection plate 20,40, and there will be no bending stress on the threaded section 113.

FIG. 9 schematically illustrates a multi-coupling device 10 on a tool carrier 120 of a detachable equipment 100 according to an example. The detachable equipment 100 may be a front loader. The front loader 100 is typically configured to be attached to the front of a working vehicle 1 as illustrated in FIG. 7 and may be hydraulically connected to the working vehicle 1 by means of a multi-coupling device 10 as disclosed in any of FIGS. 1-6. Furthermore, the front loader 100 may be hydraulically connected to a tool (125 in FIG. 7), such as a bucket or similar, by means of a multi coupling device 10 as disclosed in any of FIGS. 1-8. FIG. 9 shows the tool carrier 120 of the detachable equipment 100 comprising a multi-coupling device 10 for hydraulic connection to a tool.

Thus, the multi-coupling device 10 comprises a first connection plate 20 configured to be fixedly attached to the detachable equipment 100 and a second connection plate 40 configured to be attached to the tool, wherein the first connection plate 20 and the second connection plate 40 comprise at least two corresponding female and male couplings 30, 50 configured to be connected, The multi-coupling device 10 further comprises a guiding pin 60 on the first or second connection plate 20,40 and a corresponding guiding hole 62 in the first or second connection plate 20,40 for receiving said guiding pin 60. The female couplings 50 have an inner conical section 54 for guiding the male couplings 30.

The guiding pin 60 and guiding hole 62 may be centrally arranged or the multi-coupling device 10 may comprise a single guiding pin 60 and a single guiding hole 62 arranged anywhere on the connection plate 20, 40.

In this example, the first connection plate 20 on the tool carrier 120 comprises the male couplings 30 and the second connection plate 40 on the tool comprises the female couplings 50. The first connection plate 20 further comprises the guiding hole 62 and the holding elements 22. The connection bracket 70 with the manoeuvring lever 76 is attached on the second connection plate 40.

Specifically, the first connection plate 20 is attached to a coupling bracket 122 of the tool carrier 120. The second connection plate 40 is subsequently mounted from above.

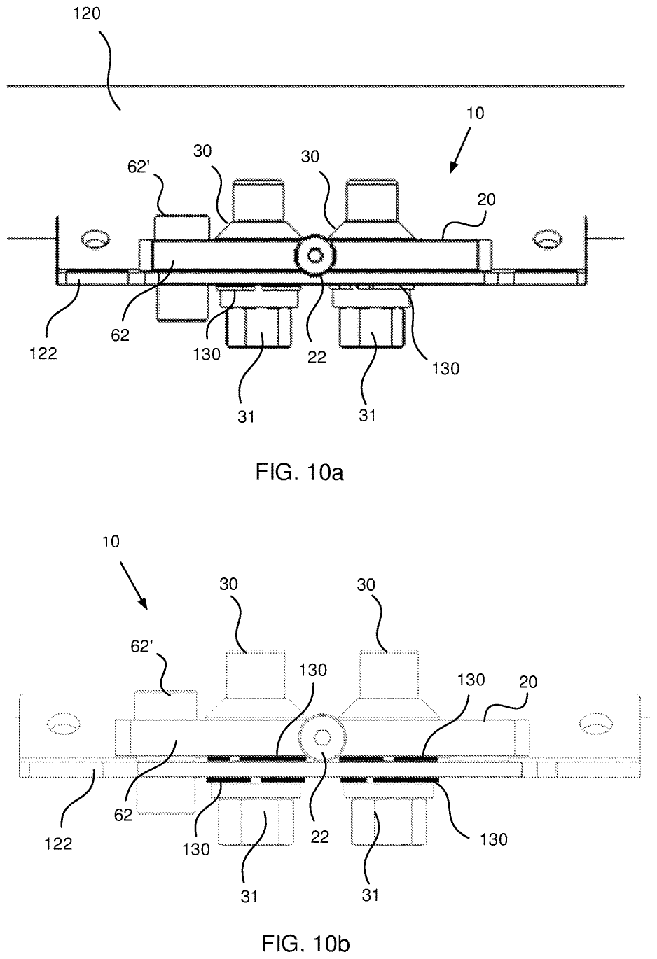

FIGS. 10a and 10b schematically illustrate parts of a multi-coupling device 10 according to examples of the present disclosure. The multi-coupling device 10 is in these examples arranged to hydraulically connect a tool 125 and a detachable equipment 100, but it is to be understood that it could be arranged to hydraulically connect a tool 125 and a working vehicle 1 or a detachable equipment 100 and a working vehicle 1.

The figures show the first connection plate 20 with the male couplings 30 arranged on the coupling bracket 122, such that the first portion 31 of the male couplings 30 extends through coupling openings in the coupling bracket 122 and the first connection plate 20 rests on the coupling bracket 122. The guiding hole 62 comprises a guiding sleeve 62′ extending on both sides of the first connection plate 20. The part of the guiding sleeve 62′ extending on the same side as the first portion 31 of the male couplings 30, may extend through a guiding hole in the coupling bracket 122.

Furthermore, in these examples, the multi-coupling device 10 comprises at least one circlip ring 130 for attachment to the tool carrier 120. Specifically, the multi-coupling device 10 comprises at least one circlip ring 130 for attachment of the first connection plate 20 to the tool carrier 120. Typically, the multi-coupling device 10 comprises at least one circlip ring 130 per coupling 30, 50 on the first connection plate 20.

FIG. 10a shows an example where each male coupling 30 on the first connection plate 20 comprises a circlip ring 130 arranged around the coupling body, clamped between the first portion 31 of the male coupling 30 and the coupling bracket 122.

FIG. 10b shows an example where each male coupling 30 on the first connection plate 20 comprises a first circlip ring 130 arranged around the coupling body, clamped between the first connection plate 20 and the coupling bracket 122 and a second circlip ring 130 arranged around the coupling body, clamped between the first portion 31 of the male coupling 30 and the coupling bracket 122. By using circlip rings, axial movement of the first connection plate 20 in relation to the coupling bracket 122 is prevented but rotational or swiveling movement of the male couplings 30 and thus the first connection plate 20 is enabled. This way, connecting hydraulic lines to the first portions 31 of the male couplings 30 will be facilitated.

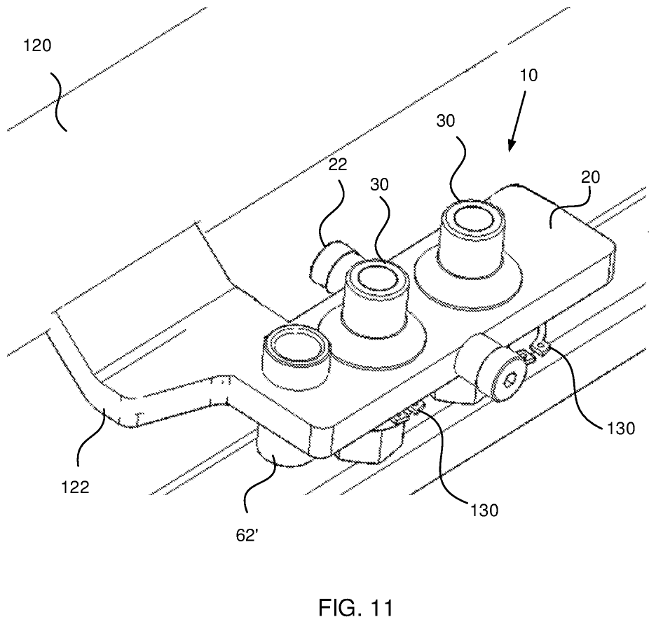

FIG. 11 schematically illustrates a part of a multi-coupling device 10 according to an example of the present disclosure. The multi-coupling device 10 may be configured as disclosed in any of FIGS. 9, 10a and 10b, with the difference that the first connection plate 20 is an integrated part of the tool carrier 120. More specifically, the first connection plate 20 is integrated in the coupling bracket 122 of the tool carrier 120. The first connection plate 20 is thus part of the connection bracket 122. In such event, the multi-coupling device 10 may comprise circlip rings 130 arranged around the coupling bodies, clamped between the first portion 31 of the male couplings 30 and the first connection plate 20.

The foregoing description of the examples of the present disclosure is provided for illustrative and descriptive purposes. It is not intended to be exhaustive or to restrict the disclosure to the variants described. Many modifications and variations will obviously be apparent to one skilled in the art. The examples have been chosen and described in order best to explain the principles of the disclosure and its practical applications and hence make it possible for specialists to understand the disclosure for various examples and with the various modifications appropriate to the intended use.

1. A multi-coupling device (10) for connecting multiple hydraulic lines of a working vehicle (1) and a detachable equipment (100), the multi-coupling device (10) comprising:
a first connection plate (20) configured to be fixedly attached to the working vehicle (1); and
a second connection plate (40) configured to be moveably attached to the detachable equipment (100),
wherein the first connection plate (20) and the second connection plate (40) comprise at least two corresponding female and male couplings (30, 50) configured to be connected, wherein the multi-coupling device (10) comprises a centrally arranged guiding pin (60) on the first or second connection plate (20, 40) and a corresponding centrally arranged guiding hole (62) in the first or second connection plate (20, 40) for receiving said guiding pin (60), and wherein the female couplings (50) have an inner conical section (54) for guiding the male couplings (30).

2. The multi-coupling device (10) according to claim 1, wherein a second portion (32) of the male couplings (30) comprises a conical base (34) corresponding to the conical inner section (54) of the female couplings (50).

3. The multi-coupling device (10) according to claim 1 or 2, wherein the female couplings (50) and the male couplings (30) are symmetrically arranged around the guiding pin (60) respectively the guiding hole (62).

4. The multi-coupling device (10) according to any one of the preceding claims, further comprising a connection bracket (70) pivotally attached to the first connection plate (20) or the second connection plate (40), the bracket (70) comprising two cam portions (72) arranged on opposite sides of the connection plate (20, 40), wherein each cam portion (72) comprises an eccentric slot (74) configured to receive a holding element (22) of the other connection plate (20, 40), such that when the connection bracket (70) is pivoted from an open position towards a closed position, the first connection plate (20) and the second connection plate (40) are moved closer and ultimately held together.

5. The multi-coupling device (10) according to claim 4, wherein each holding element (22) comprises a screw (110) with a cylindrical support section (112), a threaded section (113) and a conical section (114) between the support section (112) and the threaded section (113), wherein the support section (112) is configured to be received in the eccentric slot (74) of the cam portion (72).

6. The multi-coupling device (10) according to claim 4 or 5, further comprising a manoeuvring lever (75) removably attached to one side of the connection bracket (70).

7. The multi-coupling device (10) according to any one of claims 4-6, further comprising a safety mechanism (80) for locking the position of the connection bracket (70) in relation to the connection plate (20, 40), the safety mechanism (80) comprising a spring loaded locking element (82) removably attached to the connection plate (20, 40) on which the connection bracket (70) is arranged.

8. The multi-coupling device (10) according to claim 7, wherein the connection bracket (70) is formed by bending an elongated metal sheet with identically shaped cam portions at each end.

9. The multi-coupling device (10) according to claim 7 or 8, wherein the locking element (82) comprises a hook portion (84) configured to engage with at least one correspondingly shaped peripheral recess (76) on one of the cam portions (72) of the connection bracket (70).

10. The multi-coupling device (10) according to claim 9, wherein the cam portion (72) comprises a first peripheral recess (76′) for locking the connection bracket in the closed position, and a second peripheral recess (76″) for locking the connection bracket in the open position.

11. The multi-coupling device (10) according to any one of claim 8-10, wherein the safety mechanism (80) comprises a torsion spring (86) arranged around a pivot shaft on which the locking element (82) is arranged, and connected to the locking element (82) and the connection plate (20, 40).

12. The multi-coupling device (10) according to any one of the preceding claims, further comprising individual coupling covers (90) for the first connection plate (20), each coupling cover (90) comprising a hood (92) configured to cover a second portion (32, 52) of the coupling, a retaining portion (96) connected to a first portion (31, 51) of the same coupling and a strap (94) connecting the hood (92) and the retaining portion (96).

13. The multi-coupling device (10) according to claim 12, wherein the first connection plate (20) comprises a groove (24) at a first end of the first connection plate (20), wherein the straps (94) of the individual coupling covers (90) extends through the groove (24).

14. The multi-coupling device (10) according to claims 12 or 13, further comprising a housing (42) at least partly covering the second connection plate (40), the housing (42) having opposite side walls (44) extending beyond the second connection plate (40) in direction of the second portion (32, 52) of the couplings (30, 50), such that the side walls (44) obstruct insertion of an object through the eccentric slot when the connection bracket (70) is in the open position.

15. The multi-coupling device (10) according to any one of the preceding claims, further comprising an electrical connection (2) for connecting at least one electrical line between the working vehicle (1) and the equipment (100), the electrical connection (2) comprising corresponding electric connectors (3′, 3″) arranged on the first connection plate (20) and the second connection plate (40).

16. A multi-coupling device (10) for connecting multiple hydraulic lines of a detachable equipment (100) of a working vehicle (1) and a tool (125) connected to the detachable equipment (100), the multi-coupling device (10) comprising:
a first connection plate (20) configured to be fixedly attached to the detachable equipment (100); and
a second connection plate (40) configured to be moveably attached to the tool (125),
wherein the first connection plate (20) and the second connection plate (40) comprise at least two corresponding female and male couplings (30, 50) configured to be connected, wherein the multi-coupling device (10) comprises a centrally arranged guiding pin (60) on the first or second connection plate (20, 40) and a corresponding centrally arranged guiding hole (62) in the first or second connection plate (20, 40) for receiving said guiding pin (60), and wherein the female couplings (50) have an inner conical section (54) for guiding the male couplings (30).

17. The multi-coupling device (10) according to claim 16, wherein a second portion (32) of the male couplings (30) comprises a conical base (34) corresponding to the conical inner section (54) of the female couplings (50).

18. The multi-coupling device (10) according to claim 16 or 17, further comprising a connection bracket (70) pivotally attached to the first connection plate (20) or the second connection plate (40), the bracket (70) comprising two cam portions (72) arranged on opposite sides of the connection plate (20, 40), wherein each cam portion (72) comprises an eccentric slot (74) configured to receive a holding element (22) of the other connection plate (20, 40), such that when the connection bracket (70) is pivoted from an open position towards a closed position, the first connection plate (20) and the second connection plate (40) are moved closer and ultimately held together.

19. The multi-coupling device (10) according to claim 18, further comprising a manoeuvring lever (76) removably attached to one side of the connection bracket (70).

20. The multi-coupling device (10) according to claim 18 or 19, further comprising a safety mechanism (80) for locking the position of the connection bracket (70) in relation to the connection plate (20, 40), the safety mechanism (80) comprising a spring loaded locking element (82) removably attached to the connection plate (20, 40) on which the connection bracket (70) is arranged.

21. The multi-coupling device (10) according to claim 20, wherein the connection bracket (70) is formed by bending an elongated metal sheet with identically shaped cam portions at each end.

22. The multi-coupling device (10) according to claim 20 or 21, wherein the locking element (82) comprises a hook portion (84) configured to engage with at least one correspondingly shaped peripheral recess (76) on one of the cam portions (72) of the connection bracket (70).

23. The multi-coupling device (10) according to claim 22, wherein the cam portion (72) comprises a first peripheral recess (76′) for locking the connection bracket in the closed position, and a second peripheral recess (76″) for locking the connection bracket in the open position.

24. The multi-coupling device (10) according to any one of claim 21-23, wherein the safety mechanism (80) comprises a torsion spring (86) arranged around a pivot shaft on which the locking element (82) is arranged, and connected to the locking element (82) and the connection plate (20, 40).

25. The multi-coupling device (10) according to any one of claims 16-24 further comprising individual coupling covers (90) for the first connection plate (20), each coupling cover (90) comprising a hood (92) configured to cover a second portion (32, 52) of the coupling, a retaining portion (96) connected to a first portion (31, 51) of the same coupling and a strap (94) connecting the hood (92) and the retaining portion (96).

26. The multi-coupling device (10) according to any one of claims 16-25, wherein the first connection plate (20) is integrated in a coupling bracket (122) of a tool carrier (120) of the detachable equipment (100).

27. The multi-coupling device (10) according to any one of claims 16-26, further comprising circlip rings (130) for attachment to the detachable equipment (100).

28. A working vehicle (1) with a detachable equipment (100) and a tool (125), the working vehicle (1) comprising a multi-coupling device (10) according to any one of claims 1-27.
